(19) United States
(12) Patent Application Publication
(10) Pub. No.: US 2026/0023944 A1
(43) Pub. Date: Jan. 22, 2026

(54) HANDS-FREE DIGITAL SCANNING DEVICE AND METHOD OF USING

(71) Applicant: Tony Soyad, Warren, MI (US)

(72) Inventor: Tony Soyad, Warren, MI (US)

(21) Appl. No.: 19/276,615

(22) Filed: Jul. 22, 2025

Related U.S. Application Data
(60) Provisional application No. 63/673,899, filed on Jul. 22, 2024.

(51) Int. Cl. G06K 7/10; G06K 7/14

(52) U.S. Cl. CPC G06K 7/10881; G06K 7/1413; G06K 7/1417

(57) ABSTRACT

A digital scanning device for scanning a machine-readable code by a user is disclosed. The digital scanning device can include an optical scanner for reading the machine-readable code, a display for showing data related to the machine-readable, a control for user operation, a receiving means, and an attachment means for coupling the digital scanning device to the user. The display can be positioned between a line of sight of the user and the machine-readable code, allowing the user to see both the code and related data easily. The receiving means and attachment means can enable the digital scanning device to be worn, allowing hands-free operation. The arrangement of these features can improve efficiency and make scanning tasks easier.

### CROSS-REFERENCE TO RELATED APPLICATIONS

This application claims the benefit of U.S. Provisional Application No. 63/673,899, filed on Jul. 22, 2024. The entire disclosure of the above application is incorporated herein by reference.

### FIELD

The present technology relates to digital scanning devices, and, more particularly, to a digital scanner for scanning bar and quick response (QR) codes.

### INTRODUCTION

This section provides background information related to the present disclosure which is not necessarily prior art.

Barcode and QR code scanners are tools used across various industries to streamline data capture and inventory management. Such devices play a role in improving operational efficiency and maintaining accurate records. Barcode and QR code scanners can be employed in retail environments to rapidly process a transaction and manage stock levels by scanning product codes at checkout counters and during inventory audits. In warehousing and logistics, scanners can help track shipments and update inventory systems in real time as goods move through supply chains. Healthcare facilities can utilize barcode and QR code scanners to support accuracy in patient care management, by scanning medication labels and patient wristbands to verify treatments and record medical information. Additionally, QR code scanners have become increasingly popular in marketing and information dissemination, enabling consumers to access digital content by scanning codes on advertisements, product packaging, or event tickets.

Barcode and QR code scanners have required manual operation, necessitating physical handling of the scanner to capture data from barcodes and QR codes. These methods involve repeated actions, such as picking up and setting down the scanner, as well as frequently shifting the user's attention between the scanning task and a computer screen to verify information. Such processes can be cumbersome and time-consuming, particularly in fast-paced environments like retail stores, warehouses, and logistics centers where efficiency and speed are essential.

The physical design of many bar and QR code scanners does not support continuous, hands-free operation. Users dedicate one hand to holding the barcode and QR code scanner, which can limit their ability to perform other tasks at the same time. This limitation can be particularly problematic in settings where users would benefit from having both hands free for handling items or performing additional tasks. The lack of ergonomic features and the requirement for manual interaction with devices and computer systems can result in workflows that are less efficient.

Accordingly, there is a need for a digital scanning device for scanning a machine-readable code.

### SUMMARY

In concordance with the instant disclosure, a digital scanning device for scanning a machine-readable code, has surprisingly been discovered. The present technology includes articles of manufacture, systems, and processes that relate to a digital scanning device for scanning machine-readable codes and designed to be worn by a user, thereby facilitating hands-free operation and enhancing operational efficiency.

In certain embodiments, a digital scanning device for scanning a code by a user is provided. The digital scanning device can include an optical scanner, a display, a control, a receiving means, and an attachment means. The optical scanner can read the machine-readable code and can be disposed opposite the display, which can visually present data corresponding to the machine-readable code. The control can allow the user to operate the digital scanning device. The receiving means and attachment means can couple the digital scanning device to the user, enabling hands-free operation.

In certain embodiments, a method of using a digital scanning device for scanning a code by a user is provided. The method can include a step of providing a digital scanning device as described herein. The method can further comprise coupling the attachment means to the receiving means and coupling the digital scanning device to the user.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a digital scanning device, according to an embodiment of the present disclosure;

FIG. 2 is a bottom perspective view of the digital scanning device, according to the embodiment shown in FIG. 1;

FIG. 3 is a top perspective view of the digital scanning device, according to the embodiment shown in FIG. 1;

FIG. 4 is a side perspective view of the digital scanning device, according to the embodiment shown in FIG. 1;

FIG. 5 is a top perspective view of a digital scanning device, according to an embodiment of the present disclosure;

FIG. 6 is a bottom perspective view of the digital scanning device, according to the embodiment shown in FIG. 5;

FIG. 7 is a side perspective view of the digital scanning device, according to the embodiment shown in FIG. 5;

FIG. 8 is a perspective view of the digital scanning device, according to the embodiment shown in FIG. 5;

FIG. 9 is a perspective view of a digital scanning device coupled to a user, according to an embodiment of the present disclosure;

FIG. 10 is a flow chart illustrating a method of using a digital scanning device for scanning a machine-readable code; and

FIGS. 11 and 12 are a flow chart illustrating a method of managing inventory, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the functionality and usability of a digital scanning device by providing a digital scanner for scanning bar and QR codes that can enhance operational efficiency. The arrangement of components, including the placement of the optical scanner, display, and control interface, can allow for seamless interaction and case of use. The digital scanning device can eliminate the need for an external monitor to view data corresponding to the scanned code, thereby militating system complexity, minimizing the physical footprint of the equipment, and enhancing portability and case of deployment in various environments. Additionally, the digital scanning device can permit the user to operate it in a manner that allows both hands to remain free for carrying, handling, or moving objects. This hands-free operation can be particularly advantageous in high-throughput or dynamic settings, such as retail stores, warehouses, logistics centers, and healthcare facilities, where users may frequently manage physical items while simultaneously needing to capture and verify data. The combination of integrated data display and hands-free functionality can enhance ergonomic efficiency, militate against operator fatigue, streamline workflow, and ultimately contribute to greater overall productivity and accuracy in operational tasks.

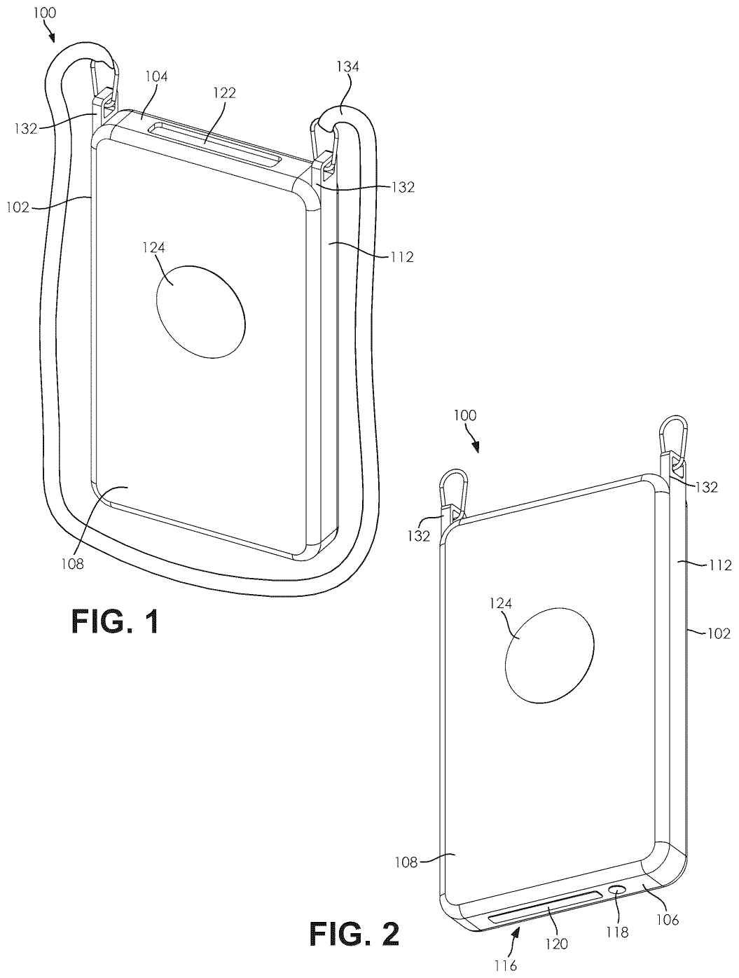

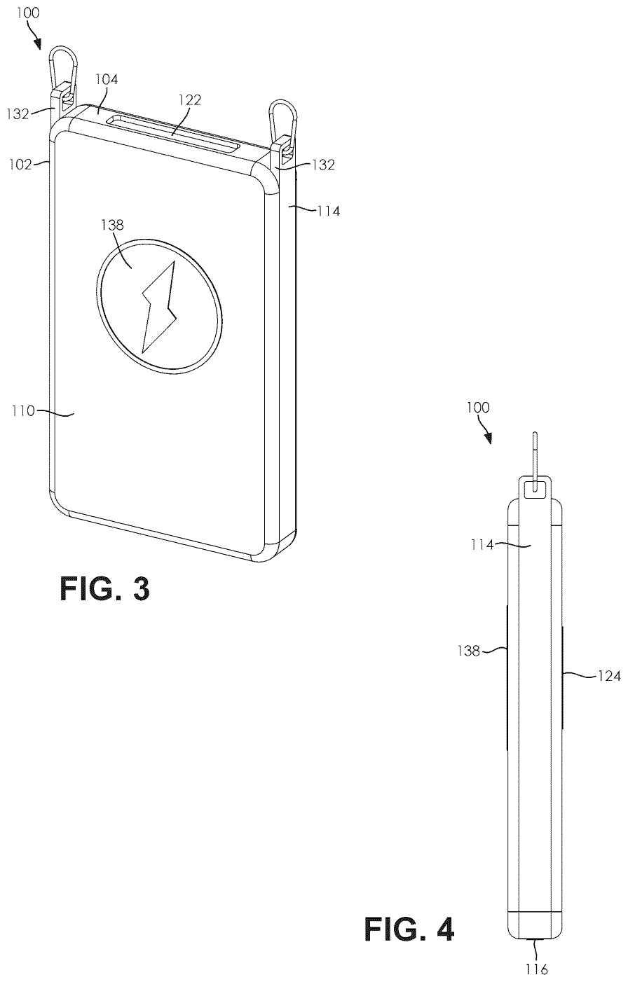

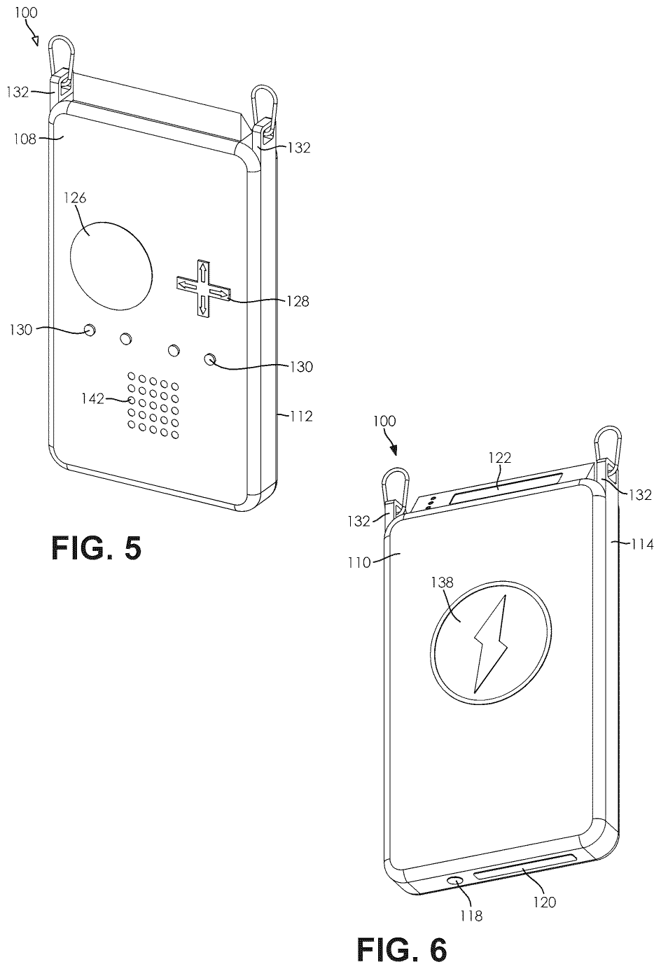

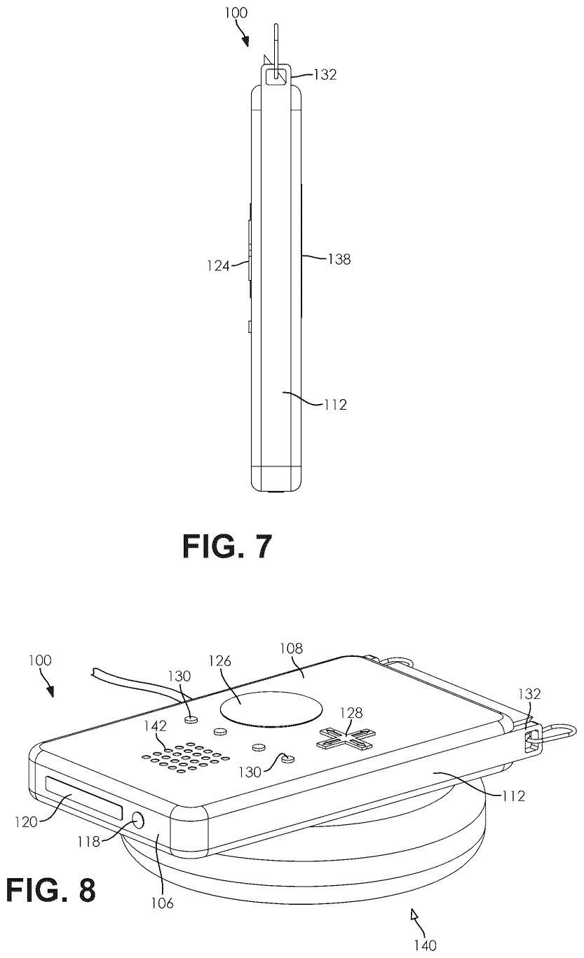

In certain embodiments, and with reference to FIGS. 1-8, a digital scanning device 100 is shown. The digital scanning device 100 can include a body 102, structured as a cuboid with six rectangular sides, including a first side 104, a second side 106, a third side 108, a fourth side 110, a fifth side 112, and a sixth side 114. The first side 104 may be designated as the top, the second side 106 as the bottom, the third side 108 as the front, the fourth side 110 as the rear, the fifth side 112 as the right, and sixth side 114 as the left. It should be understood that the digital scanning device 100 can be formed as a unitary body or as a body assembled from multiple components. In certain embodiments, the third side 108 can have a greater surface area than either the first side 104 or the second side 106. For example, the third side 108 can extend along both the length L and width W of the body 102, providing a surface that can accommodate features such as a display, an optical scanner, or other components.

It should be appreciated that the digital scanning device 100 can include various geometric shapes, not limited to a cuboid structure. The digital scanning device 100 can be designed in alternative forms such as cylindrical, spherical, or other polygonal configurations, depending on the specific application requirements and ergonomic considerations. These alternative shapes can provide different advantages in terms of device stability or component arrangement, while still maintaining the functionality and features described herein. The choice of geometric shape can be influenced by factors such as the intended use environment, the need for compactness, or aesthetic preferences. One having ordinary skill in the art can select a suitable geometric shape of the digital scanning device 100 within the scope of the present disclosure.

It should be appreciated that the body 102 can include a material suitable for providing mechanical strength and protection for internal components of the digital scanning device 100. The material can include a plastic, a thermoplastic polymer, a thermosetting polymer, or a composite material. One having ordinary skill in the art can select a suitable material for the body 102 of the digital scanning device 100 within the scope of the present disclosure.

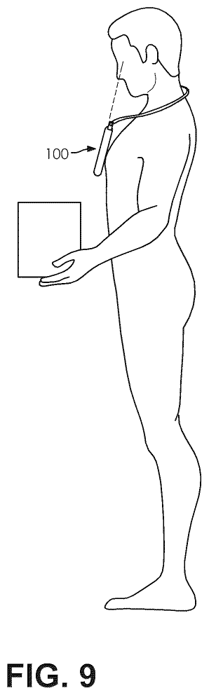

In certain embodiments, and with reference to FIGS. 1-9, the digital scanning device 100 can include an optical scanner 116 configured to read a machine-readable code and can be disposed on the second side 106. The optical scanner 116 can include a light source 118 and a sensor 120, enabling the detection and interpretation of a machine-readable code. The light source 118 can be configured to illuminate the machine-readable code, while the sensor 120 can capture the reflected light from the machine-readable code. The light source can include a laser, a light-emitting diode (LED), and combinations thereof. The light source 118 and sensor 120 can be oriented to project and receive light along a longitudinal line of the digital scanning device 100 extending outward from the second side 106. In certain embodiments, the optical scanner 116 can be disposed at an angle relative to the longitudinal axis, whereby the optical scanner 116 can be directed obliquely outward from the second side 106. In certain embodiments, the optical scanner 116 can be disposed on the third side 108. Positioning the optical scanner 116 so that it faces in a direction substantially perpendicular to the longitudinal axis of the body 102 can facilitate scanning larger objects because it can provide a wider field of view. It should be understood that a machine-readable code can include a bar code, a QR code, a Data Matrix code, an Aztec code, and combinations thereof. In certain embodiments, the optical scanner 116 can be configured to detect and interpret any one or more of these code types.

It should be appreciated that the optical scanner 116 can militate against errors commonly associated with manual scanning, such as misreads or incomplete data capture, which are prevalent in fast-paced environments. The sensitivity and precision of the optical scanner 116 can quickly interpret information from various angles and distances, making the digital scanning device 100 effective for scanning large volumes of items swiftly. The optical scanner 116 can be configured to automatically initiate scanning when a machine-readable code is detected within a predetermined distance from the digital scanning device 100.

In certain embodiments, the digital scanning device 100 can include a display 122 configured to visually present data corresponding to the machine-readable code and can be disposed on the first side 104 of the body 102. The display 122 can be strategically placed to be intermediate to the line of sight of the user and the machine-readable code, facilitating viewing of the scanned data corresponding to the machine-readable code. The display 122 can be visible to the user while the user is scanning the code. The display 122 can include a touchscreen, allowing for interactive user input and control. The touchscreen can allow users to effortlessly browse through menus, make selections, and even enter data directly on the scanner. This capability can be beneficial in environments where efficiency is important, as it militates against the need for additional devices or peripherals for data entry and retrieval. The touchscreen can be responsive and durable and capable of withstanding frequent use in various industrial environments without compromising on sensitivity or visibility.

In certain embodiments, one having ordinary skill in the art can consider ergonomic factors for the positioning of the display 122. The display 122 can be positioned for optimal viewing without causing strain to the user. For example, the display 122 can be disposed at an angle relative to the longitudinal axis of the digital scanning device 100, whereby the display 122 can be intermediate to a line of sight of the user and the machine-readable code. The angle of the display 122 can be adjustable. One having ordinary skill in the art can select a suitable angle of the display 122 within the scope of the present disclosure. The ergonomic placement can help in maintaining a natural posture during operation, militating against physical strain and providing comfort during prolonged use. The display 122 can include a high-resolution to allow all information to be clear and easily readable, which is vital for militating against errors in data interpretation and promoting accurate processing of scanned information.

In certain embodiments, the digital scanning device 100 can include a control 124 configured to allow the user to control the digital scanning device 100 and can be disposed on the third side 108 of the body 102. The control 124 can include a scanning button 126, a directional pad (D-pad) 128, a rocker switch (not shown), and navigation buttons 130. This configuration can allow the user to operate the digital scanning device 100, providing intuitive access to various functions.

In certain embodiments, the digital scanning device 100 can include a receiving means 132 and an attachment means 134. The receiving means 132 and the attachment means 134 can couple the digital scanning device 100 to the user. The receiving means 132 can be disposed at opposite ends of the first side 104, allowing for secure attachment via a lanyard 136 or strap, enabling the digital scanning device 100 to be worn around by the user, such as around a neck or on the torso. In certain embodiments, the receiving means 132 can be disposed on the fifth side 112 and the sixth side 114. The receiving means 132 can include, for example, a loop, an eyelet, a hook, a ring, or a slot. The attachment means 134 can include, for example, the lanyard 136, a chain, or a strap, providing flexibility in how the digital scanning device 100 can be coupled to the user.

In certain embodiments, the digital scanning device 100 can include a wireless charging module 138, which can receive power from an inductive charging pad 140. The wireless charging module 138 can facilitate recharging without the need for direct cable connections, enhancing the usability of the digital scanning device 100 in operational environments. It should be understood that the wireless charging module 138 can be integrated into the digital scanning device 100, allowing for seamless operation and maintenance.

In certain embodiments, the digital scanning device 100 can include a wireless communication module (not shown), which can transmit scanning data to an external computing system. The external computing system can include a local server, a remote database, a smartphone, or a networked inventory system, and combinations thereof. The wireless communication module can allow for seamless integration into existing data management systems, enhancing the efficiency of data processing and storage.

In certain embodiments, the digital scanning device 100 can include a speaker 142. The speaker 142 can provide audio feedback to the user, indicating successful scanning or other operational statuses. The speaker 142 can enhance the user experience by providing immediate confirmation of actions, militating the need for visual confirmation.

In certain embodiments, the digital scanning device 100 can include an indicator light 144 to provide visual feedback to the user. The indicator light can be disposed on the first side 104. The indicator light 144 can signal various operational states of the digital scanning device 100, such as power status, scanning readiness, or error conditions. The indicator light 144 can enhance the usability of the digital scanning device 100 by providing visual cues to the user.

In certain embodiments, the digital scanning device 100 can include a memory (not shown) to store scanned data. The memory can allow for the temporary or permanent storage of scanned information, enabling the user to access and review scanned data as needed. The memory can enhance the functionality of the digital scanning device 100 by providing a means for data retention and retrieval.

In certain embodiments, the digital scanning device can include electronic components such as a processor, memory, and a power source. The processor can be operably coupled to the optical scanner, display, control, and any communication modules, and can be configured to execute instructions for reading machine-readable codes, processing associated data, and controlling display output. A person having ordinary skill in the art will understand that appropriate electronic circuitry, firmware, and software may be implemented to facilitate these operations.

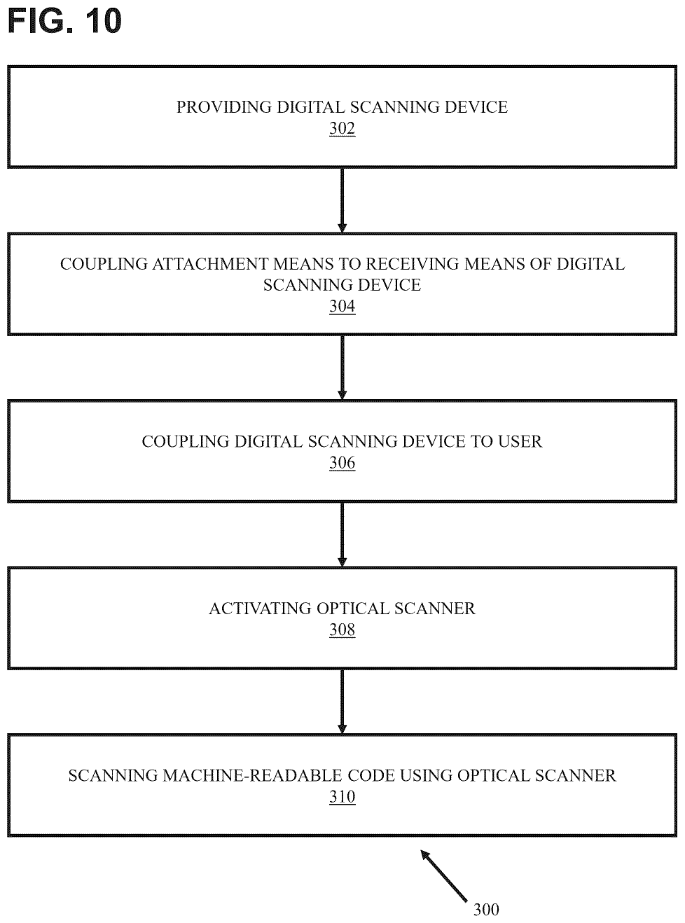

In certain embodiments, and with reference to FIG. 10, a method 300 of using the digital scanning device 100 is provided. The method 300 can include a step 302 of providing a digital scanning device 100 such as the digital scanning device 100 as described herein. The method 300 can include a step 304 of coupling the attachment means 134 to the receiving means 132 of the digital scanning device 100. Once the attachment means 134 is coupled to the digital scanning device 100, the method 300 can include a step 306 of coupling the digital scanning device 100 to the user. The digital scanning device 100 can be coupled to the user, such as around the neck or on the torso. In certain embodiments, the method 300 can include a step 308 of activating the optical scanner 116. The optical scanner 116 can be activated manually by the user by manipulation of the control 124, or the optical scanner 116 can be activated automatically. The method can include a step 310 of scanning the machine-readable code using the optical scanner 116. When the optical scanner 116 reads the machine-readable code, the corresponding data can be processed by the digital scanning device 100 and visually presented on the display 122. This can allow the user to confirm the scanned information without the need for an external monitor or a separate computing device.

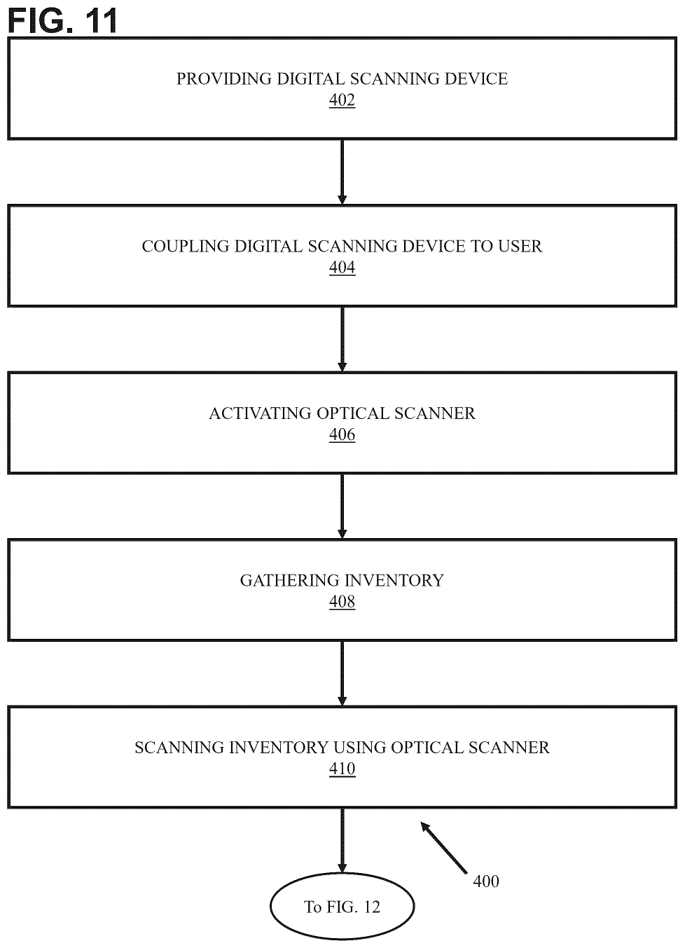

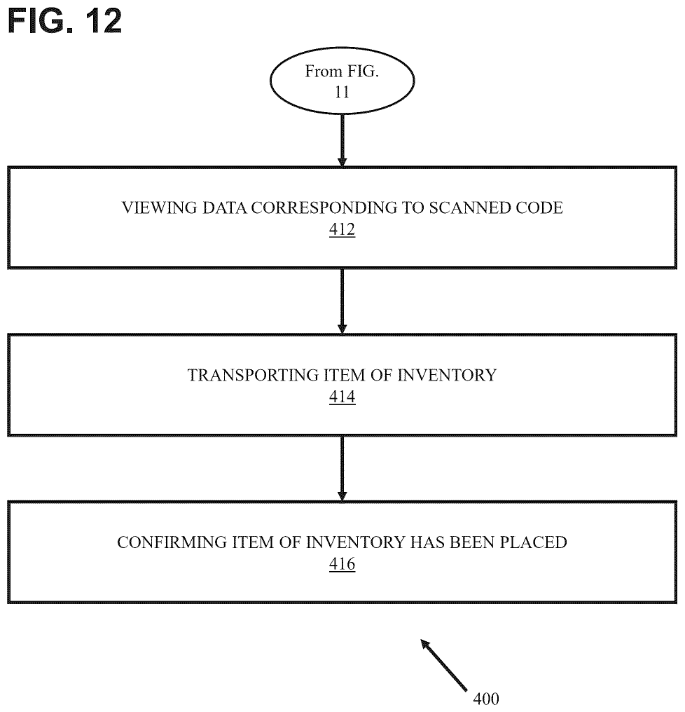

In certain embodiments, and with reference to FIG. 11, a method 400 of managing inventory is provided. The method 400 can include a step 402 of providing a digital scanning device such as the digital scanning device 100 as described herein. The method 400 can include a step 404 of coupling the digital scanning device 100 to a user. For example, the digital scanning device 100 can be coupled to the user using an attachment means 134, such as a strap, a harness, a lanyard, or similar feature that can engage the receiving means 132 of the digital scanning device 100. This can allow the user to operate the digital scanning device 100 in a substantially hands-free manner while performing other tasks. The method 400 can include a step 406 of activating the optical scanner 116 of the digital scanning device 100. Activation can be performed by manipulating a control 124, such as a button, switch, touch-sensitive surface, or directional pad (D-pad). In certain embodiments, activation can occur automatically in response to proximity sensing or motion detection near a machine-readable code. The method 400 can include a step 408 of gathering inventory, such as a product or item stored within a warehouse, retail environment, or other inventory-managed location. The method 400 can include a step 410 of scanning the item of inventory using the optical scanner 116. The method 400 can include a step 412 of viewing data corresponding to the scanned code. The data can include information regarding the proper storage or placement location of the item of inventory, such as an aisle number, shelf identifier, bin location, basket, or other designated area within the facility. The method 400 can include a step 414 of transporting the item of inventory to the proper storage or placement location. Once the item of inventory is transported to the proper storage or placement location, the method 400 can include a step 416 of confirming that the item of inventory has been placed. The confirmation step can record the completion of the task in an inventory management system, ensuring that inventory records remain accurate and up to date. It should be understood that the method 400 can be repeated for subsequent pieces of inventory, allowing the user to continue scanning additional items, receiving placement instructions, transporting items to designated locations, and confirming the placement of each item. This iterative process can support efficient and accurate inventory management, militate against the likelihood of errors, and streamline operations in environments.

In certain embodiments, the method 400 can also be performed in reverse for the purpose of retrieving items from storage for shipping, order fulfillment, or display on a retail floor. In such embodiments, the user can activate the optical scanner 116 and scan a machine-readable code corresponding to a picking list, order number, or specific item to be retrieved. The display 122 can present information indicating the storage location of the desired item, such as an aisle, shelf, bin, or rack location. The user can then proceed to the indicated location, locate and retrieve the item, and optionally scan the item again to confirm retrieval. After retrieving the item, the user can manipulate the control of the digital scanning device 100 to confirm removal of the item from inventory records and to direct the item toward a shipping area, packing station, or display location. This reverse operation can similarly enhance inventory accuracy, improve workflow efficiency, and facilitate seamless transitions between storage, fulfillment, and retail activities.

Advantageously, the digital scanning device 100 can provide a substantially hands-free scanning solution that enhances user efficiency and convenience. The ergonomic design, characterized by its strategic arrangement of components, can allow the digital scanning device 100 to be worn by the user, thereby freeing the hands of the user for other tasks during the scanning process. The inclusion of an optical scanner, display, and control interface, each optimally positioned on different sides of the digital scanning device 100, can facilitate intuitive operation and easy viewing of scanned information. Furthermore, the integration of wireless charging and communication modules can ensure seamless power management and data transmission, enabling the digital scanning device 100 to be effectively incorporated into existing data management systems. The approach to the design and functionality of the digital scanning device 100 can overcome the challenges associated with handheld scanners, offering a practical and efficient solution for various operational environments.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A digital scanning device for scanning a code by a user, comprising:
a body having a first side, a second side, and a third side, the body including:
an optical scanner, the optical scanner configured to read the code;
a display, the display configured to visually present data corresponding to the code;
a control, the control configured to allow the user to control the digital scanning device;
at least one receiving means; and
an attachment means configured to be received by the receiving means to thereby couple the digital scanning device to the user,
wherein
the optical scanner is disposed opposite the display, and
the third side has a greater surface area than the first side and the second side.

2. The digital scanning device of claim 1, wherein the code is a machine-readable code selected from a group consisting of a bar code, a QR code, a Data Matrix code, an Aztec code, and combinations thereof.

3. The digital scanning device of claim 1, wherein the body further includes a fourth side, a fifth side, and a sixth side.

4. The digital scanning device of claim 3, wherein the optical scanner is disposed on the second side.

5. The digital scanning device of claim 4, wherein the display is disposed on the first side.

6. The digital scanning device of claim 5, wherein the control is disposed on the third side.

7. The digital scanning device of claim 6, wherein the at least one receiving means is disposed on the first side.

8. The digital scanning device of claim 1, wherein the optical scanner includes a light source and a sensor.

9. The digital scanning device of claim 1, wherein the display is disposed on the first side, whereby the display is intermediate to a line of sight of the user and the code.

10. The digital scanning device of claim 1, wherein the digital scanning device is disposed substantially intermediate to a line of sight of the user and the code.

11. The digital scanning device of claim 1, wherein the control includes a scanning button, a directional pad (D-pad), and a plurality of navigation buttons.

12. The digital scanning device of claim 1, further comprising a wireless charging module.

13. The digital scanning device of claim 12, wherein the wireless charging module is configured to receive power from an inductive charging pad.

14. The digital scanning device of claim 1, further comprising a speaker configured to produce an audible sound.

15. The digital scanning device of claim 1, further comprising a wireless communication module configured to transmit scanning data to an external computing system, the external computing system including a member selected from a group consisting of a local server, a remote database, a smartphone, a networked inventory system, and combinations thereof.

16. The digital scanning device of claim 1, wherein:
the body includes a fourth side, a fifth side, and a sixth side,
the optical scanner includes a light source and a sensor, the optical scanner is disposed on the second side,
the display is disposed on the first side, whereby the display is intermediate to a line of sight of the user and the code,
the control includes at least one of a scanning button, a directional pad (D-pad), and a plurality of navigation buttons, the control is disposed on the third side,
the receiving means is disposed on the first side; and
a wireless charging module.

17. A method of using a digital scanning device for scanning a code by a user, the method comprising:
providing a digital scanning device, the digital scanning device including:
a body having a first side, a second side, and a third side, the body including:
an optical scanner, the optical scanner configured to read the code;
a display, the display configured to visually present data corresponding to the code;
a control, the control configured to allow the user to control the digital scanning device;
a receiving means; and
an attachment means configured to be received by the receiving means to thereby couple the digital scanning device to the user,
wherein the optical scanner is disposed opposite the display, and the third side has a greater surface area than the first side and the second side;
coupling the attachment means to the receiving means; and
coupling the digital scanning device to the user.

18. The method of claim 17, further comprising activating the optical scanner.

19. The method of claim 17, further comprising scanning the code.

20. The method of claim 17, further comprising the user viewing the code to confirm the code was scanned.
